(19) United States
(12) Patent Application Publication
(10) Pub. No.: US 2004/0145489 A1
(43) Pub. Date: Jul. 29, 2004

(54) Camcorder with level sensor

(76) Inventor: Charles N. Howard, JR., Topeka, KS (US)

Correspondence Address: LITMAN LAW OFFICES, LTD., P.O. BOX 15035 CRYSTAL CITY STATION, ARLINGTON, VA, 22215, US

(21) Appl. No.: 10/349,925

(22) Filed: Jan. 24, 2003

(51) Int. Cl. G08B 21/00

(52) U.S. Cl. 340/686.1; 348/208.15; 348/207.99

(57) ABSTRACT

A device with a level sensor includes a level sensor that detects whether a predetermined position on the device has been pointing from a horizontal line parallel to ground more than a predetermined angle θ toward the ground for more than a predetermined amount of time, and alerts a device user that the predetermined position on the device has been pointing more than a predetermined angle θ toward the ground for more than a predetermined amount of time.

### BACKGROUND OF THE INVENTION

1. Field of the Invention

The present invention relates generally to video cameras and, more particularly, to a camcorder with a level sensor.

2. Description of the Related Art

Camcorders and portable cameras having a video cassette recorder are widely used for recording moving pictures. For example, many family members use camcorders to record family siblings or relatives on holidays or special occasions. It is not uncommon for users of camcorders to inadvertently point the camcorder toward the ground, or to forget to turn off the recording function before pointing the camcorder to the ground during these recording periods. It is known in the art to provide camcorders with stabilizing circuitry to inhibit the effects of vibrations during recording periods. However, no camcorder circuitry is known that alerts a camcorder user that the camcorder has been pointing more than a predetermined angle toward the ground. Therefore, a need currently exists for a camcorder with a level sensor that alerts a camcorder user that the camcorder has been pointing more than a predetermined angle toward the ground.

The related art is represented by the following references of interest.

U.S. Patent Application Publication No. 2002/0116090 A1, published on Aug. 22, 2002 for Ernest H. Fischer, describes a placement robot including a micro alignment pick-up head to hold a component for placement on a substrate. The Fischer application does not suggest a camcorder with a level sensor according to the claimed invention.

U.S. Patent Application Publication No. 2002/0146295 A1, published on Oct. 10, 2002 for Roland Schaer et al., describes a hand tool with an electronic depth stop. The Schaer et al. application does not suggest a camcorder with a level sensor according to the claimed invention.

U.S. Patent Application Publication No. 2002/0161280 A1, published on Oct. 31, 2002 for David Chatenever et al., describes an apparatus and technique for compensating the display of an image obtained from a video camera system associated with an endoscope as it is moved through various orientations. The Chatenever application does not suggest a camcorder with a level sensor according to the claimed invention.

U.S. Pat. No. 3,822,944, issued on Jul. 9, 1974 to Evan L. Hopkins et al., describes a method and apparatus for detecting orientation with respect to predetermined frames of reference particularly for use in aligning vehicle headlamps relative to frames of reference such as the true horizontal and the longitudinal axis of the vehicle. The Hopkins et al. patent does not suggest a camcorder with a level sensor according to the claimed invention.

U.S. Pat. No. 4,425,042, issued on Jan. 10, 1984 to Rex L. Smith, describes a method and apparatus for determining the position of an article. The Smith patent does not suggest a camcorder with a level sensor according to the claimed invention.

U.S. Pat. No. 5,210,620, issued on May 11, 1993 to Know-Jin Kim, describes a method and apparatus for controlling a camcorder. The Kim patent does not suggest a camcorder with a level sensor according to the claimed invention.

U.S. Pat. No. 5,412,476, issued on May 2, 1995 to William F. Marantette, describe a method and apparatus for sensing the end of a drill bit. The Marantette patent does not suggest a camcorder with a level sensor according to the claimed invention.

U.S. Pat. No. 5,432,503, issued on Jul. 11, 1995 to Gary W. Pekar, describes a device for determining the orientation of a surface relative to the horizontal. The Pekar patent does not suggest a camcorder with a level sensor according to the claimed invention.

U.S. Pat. No. 5,572,252, issued on Nov. 5, 1996 to Masafumi Naka et al., describes a method and apparatus for preventing an erroneous recording operation on a video camera. The Naka et al. patent does not suggest a camcorder with a level sensor according to the claimed invention.

U.S. Pat. No. 5,819,424, issued on Oct. 13, 1998 to Fumio Ohtomo et al., describes a laser leveling device. The Ohtomo et al. patent does not suggest a camcorder with a level sensor according to the claimed invention.

U.S. Pat. No. 6,375,395 B1, issued on Apr. 23, 2002 to Michael G. Heintzeman, describes a laser and hand held power drill case with a drill bit combination. The Heintzeman patent does not suggest a camcorder with a level sensor according to the claimed invention.

U.S. Pat. No. 6,470,251 B1, issued on Oct. 22, 2002 to Bruce W. Enix, describes a method and apparatus for controlling a hydraulically movable tool carried by a machine in order to maintain selected horizontal orientation and a selected elevation relative to an external light reference. The Enix patent does not suggest a camcorder with a level sensor according to the claimed invention.

Japan Patent document 7-156513, published on Sep. 27, 1982, describes an automatic leveling instrument. The Japan '513 document does not suggest a camcorder with a level sensor according to the claimed invention.

Japan Patent document 3-185309, published on Aug. 13, 1991, describes a level sensor. The Japan '309 document does not suggest a camcorder with a level sensor according to the claimed invention.

Japan Patent document 6-3220, published on Jan. 11, 1994, describes a method and apparatus for evaluating visual angle characteristics for a display device. The Japan '220 document does not suggest a camcorder with a level sensor according to the claimed invention.

None of the above inventions and patents, taken either singularly or in combination, is seen to describe the instant invention as claimed. Thus a camcorder with a level sensor solving the aforementioned problems is desired.

### SUMMARY OF THE INVENTION

The present invention is a camcorder with a level sensor. Alternatively, the level sensor may be incorporated into any desired device, such as a tool or the like. A device with a level sensor according to the invention includes a level sensor that detects whether a predetermined position on the device has been pointing from a horizontal line parallel to ground more than a predetermined angle θ toward the ground for more than a predetermined amount of time, and alerts the device user that the device has been pointing more than a predetermined angle θ toward the ground for more than a predetermined amount of time.

Accordingly, it is a principal aspect of the invention to provide a device including a power source and a level sensor, wherein the level sensor detects whether a predetermined position on the device has been pointing from a horizontal line parallel to ground more than a predetermined angle θ toward the ground for more than a predetermined amount of time.

It is another aspect of the present invention to provide a device including a power source, a level sensor, a controller, a memory, function keys, an audible indicator, a visual indicator, an audio input, a video input, at least one input/output connector, and a communication bus, wherein the memory includes control code stored therein including:

first instruction means for determining whether the level sensor indicates that a predetermined position on the device has been pointing away from a horizontal line parallel to the ground more than a predetermined angle θ toward the ground for more than a predetermined amount of time;

second instruction means for activating an audible indicator if the level sensor indicates that a predetermined position on the device has been pointing away from a horizontal line parallel to the ground more than a predetermined angle θ toward the ground for more than a predetermined amount of time;

third instruction means for activating a visual indicator if the level sensor indicates that a predetermined position on the device has been pointing away from a horizontal line parallel to the ground more than a predetermined angle θ toward the ground for more than a predetermined amount of time;

fourth instruction means for activating a vibratory indicator if the level sensor indicates that a predetermined position on the device has been pointing away from a horizontal line parallel to the ground more than a predetermined angle θ toward the ground for more than a predetermined amount of time;

fifth instruction means for deactivating the device if the level sensor indicates that a predetermined position on the device has been pointing away from a horizontal line parallel to the ground more than a predetermined angle θ toward the ground for more than a predetermined amount of time;

sixth instruction means for accepting user input to adjust the predetermined angle; and

seventh instruction means for accepting user input to adjust the predetermined amount of time.

Still another aspect of the present invention to provide a method for controlling a device equipped with a level sensor, the method including determining whether the level sensor indicates that a predetermined position on the device has been pointing away from a horizontal line parallel to the ground more than a predetermined angle θ toward the ground for more than a predetermined amount of time.

Yet another aspect of the present invention to provide a method for controlling a device equipped with a level sensor, the method including determining whether the level sensor indicates that a predetermined position on the device has been pointing away from a horizontal line parallel to the ground more than a predetermined angle θ toward the ground for more than a predetermined amount of time, activating an audible indicator if the level sensor indicates that a predetermined position on the device has been pointing away from a horizontal line parallel to the ground more than a predetermined angle θ toward the ground for more than a predetermined amount of time, activating a visual indicator if the level sensor indicates that a predetermined position on the device has been pointing away from a horizontal line parallel to the ground more than a predetermined angle θ toward the ground for more than a predetermined amount of time, activating a vibratory indicator if the level sensor indicates that a predetermined position on the device has been pointing away from a horizontal line parallel to the ground more than a predetermined angle θ toward the ground for more than a predetermined amount of time, deactivating the device if the level sensor indicates that a predetermined position on the device has been pointing away from a horizontal line parallel to the ground more than a predetermined angle θ toward the ground for more than a predetermined amount of time, accepting user input to adjust the predetermined angle, and accepting user input to adjust the predetermined amount of time.

It is an aspect of the invention to provide improved elements and arrangements thereof in a camcorder with a level sensor for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is an environmental view of mother recording her young child having fun outdoors with a camcorder with a level sensor according to the present invention.

FIG. 2 is a front perspective view of a camcorder with a level sensor according to the present invention.

FIG. 3 is a block diagram of a camcorder with a level sensor according to the present invention.

Similar reference characters denote corresponding features consistently throughout the attached drawings.

### DETAILED DESCRIPTION OF THE PREFERRED EMBODIMENTS

The present invention is a camcorder with a level sensor. The invention disclosed herein is, of course, susceptible of embodiment in many different forms. Shown in the drawings and described hereinbelow in detail are preferred embodiments of the invention. It is to be understood, however, that the present disclosure is an exemplification of the principles of the invention and does not limit the invention to the illustrated embodiments.

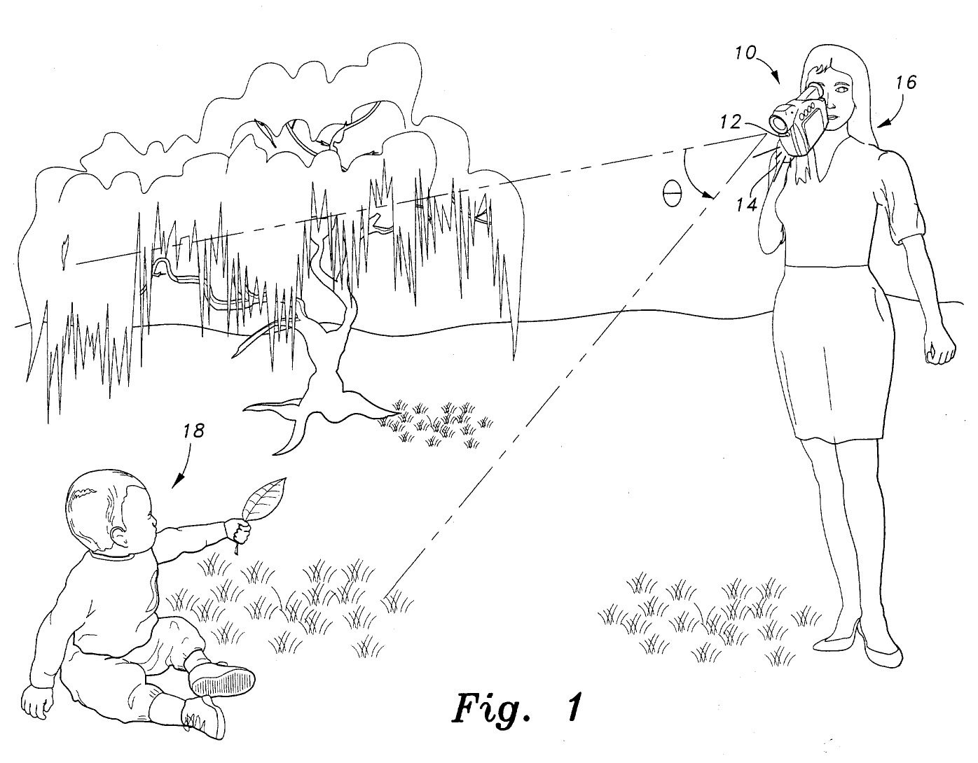

Referring to the drawings, FIG. 1 shows a camcorder 10 with a level sensor (not shown) according to the invention being used by a mother 16 to record her young child 18 having fun outdoors. The camcorder 10 includes a level sensor (not shown) for detecting whether the camcorder 10 has been pointing more than a predetermined angle θ toward the ground for more than a predetermined amount of time. Alternatively, the level sensor may be incorporated into any desired device, such as a tool or the like, according to the desires of the user. The camcorder 10 also includes a visual indicator 12 and an audible indicator 14 to alert the user 10 that the camcorder 10 has been pointing more than a predetermined angle θ toward the ground for more than a predetermined amount of time. The camcorder may also include a vibratory indicator (not shown) to alert the user 10 of the camcorder 10.

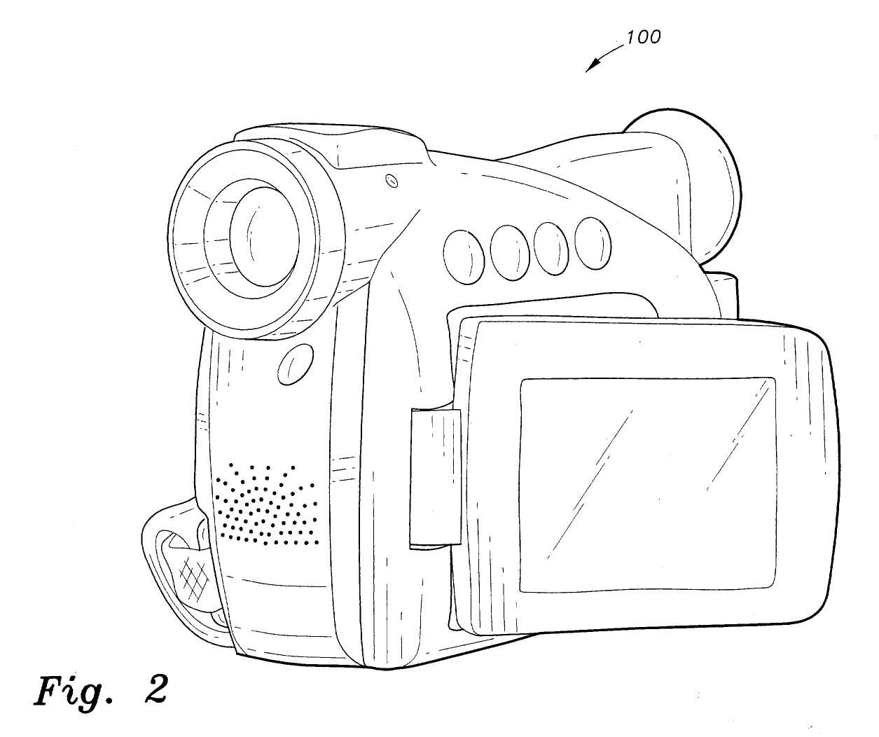

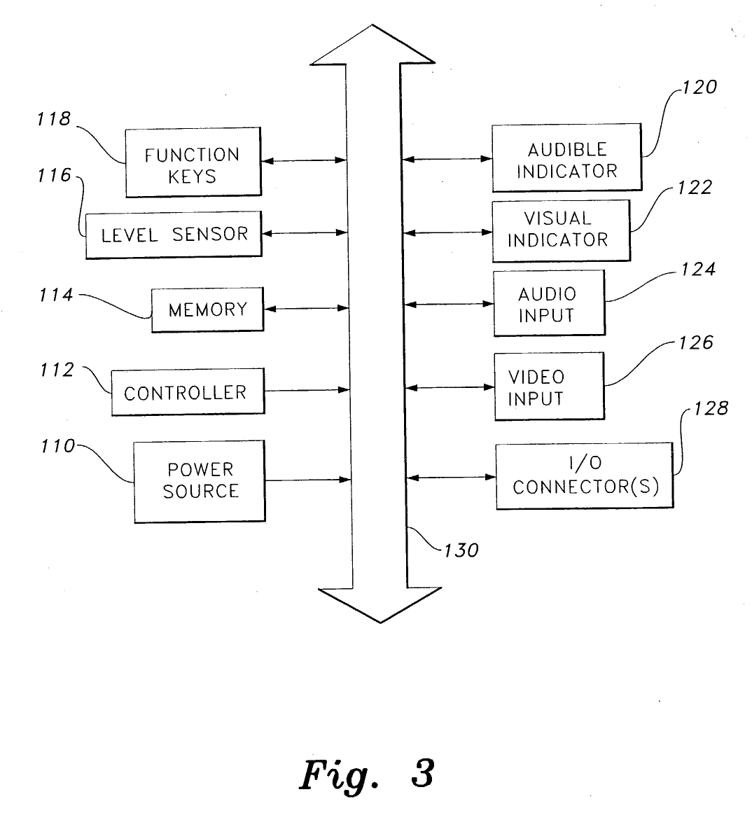

FIGS. 2 and 3 show a camcorder 100 with a level sensor 116 according to the invention. With the exception of the level sensor 116 and control code that causes the audible indicator 120, visual indicator 122, and/or vibratory sensor to alert a user that the camcorder 100 has been pointing more than a predetermined angle θ toward the ground form more than a predetermined amount of time, the camcorder 100 may be configured with any camcorder elements commonly used in the art. As shown in FIG. 3, the camcorder 100 may include a power source 110, a controller 112, memory 114, a level sensor 116, function keys 118, an audible indicator 120, a visual indicator 122, an audio input 124, a video input 126, and input/output (I/O) connector(s) 128, that are interconnected with a communication bus 130.

The power source 110, the level sensor 116, the function keys 118, the audible indicator 120, the visual indicator 122, the audio input 124, the video input 126, and the input/output (I/O) connector(s) 128 are all well known in the art and may be configured according to the desires of the user. For example, power source 110 of the camcorder 100 unit may be any known power source, such as a conventional battery, a rechargeable battery, or the like. Level sensor 116 may be any type of level sensor, such as a mercury switch or the like, configured to provide a signal when a predetermined position interconnected with the level sensor is not level. Function keys 118 enable a user of camcorder 100 to turn the camcorder on and off, to record a moving image, to stop recording, or the like. Audible indicator 120 may be any known type of audible indicator configured to emit any type of sound, such as a horn, siren, alarm, or the like. Visual indicator 122 is configured to provide visual indication to a user and may be any known type of visual indicator, such as light emitting diodes or the like. The audible input 124 is configured to receive and provide audible sound on a recorded moving image, and may be any known type of audible input, such as a microphone or the like. The video input 126 is configured to receive and provide visual images on a recorded moving image. The video input 126 may be any known type of video input, such as a CCD sensor or the like. The input/output connector(s) 128 may be any type of connector(s) known in the art, such as Peripheral Component Interconnect (PCI) connector(s), Industry Standard Architecture (ISA) connector(s), Fibre Channel-Arbitrated Loop (FC-AL) connector(s), Integrated Drive Electronics (IDE) connector(s), Small Computer Systems Interface (SCSI) connector(s), Universal Serial Bus (USB) connector(s), or the like. An I/O connector 128 may be configured for interconnecting the camcorder to an external power source, such as utility power, to power the camcorder and/or recharge any internal rechargeable batteries.

The camcorder 110 includes a communication bus 130 to communicatively interconnect the power source 110, the controller 112, the memory 114, the level sensor 116, the function keys 118, the audible indicator 120, the visual indicator 122, the audio input 124, the video input 126, and the input/output (I/O) connector(s) 128. These elements are all well known in the art and may be configured according to the desires of the user.

The controller 112 of the camcorder 110 includes a processing unit that is interconnected with the memory 114 via the communication bus 130. The memory includes read only memory (ROM) and random access memory (RAM). The ROM stores control code that is read and processed by the controller 112, and that causes the controller to perform programmed functions. The ROM may be electronically alterable (e.g., electrically programmable (EPROM), electrically eraseable programmable (EEPROM), or the like) so that the controller can be readily adapted to a particular camcorder configuration. Movement and process of instructions as well as data is controlled and accomplished by the controller 112. The RAM and the ROM may be connected to the controller 112 through several signal paths.

The controller 112 of the camcorder 100 may execute various programs under the control of the controller 112. For example, any control code stored in the memory 114 of the camcorder 100 may include instruction means for converting a signal from the video input 126 into a video signal, and for controlling an exposure time of an iris of the camcorder 100 for controlling an exposure time of the iris and the video input for keeping the proper quantity of light applied to the video input 126. The camcorder 100 may also include control code to record an video signal onto a magnetic tape or on a digital memory card.

However, the control code of the camcorder 100 of this invention specifically includes first instruction means for determining whether the level sensor 116 indicates that the lens of the video input 126 has been pointing away from a horizontal line parallel to the ground more than a predetermined angle θ toward the ground for more than a predetermined amount of time. The control code may also include second instruction means for activating an audible indicator if the level sensor 116 indicates that the lens of the video input 126 has been pointing away from a horizontal line parallel to the ground more than a predetermined angle θ toward the ground for more than a predetermined amount of time. The control code may also include third instruction means for activating a visual indicator if the level sensor 116 indicates that the lens of the video input 126 has been pointing away from a horizontal line parallel to the ground more than a predetermined angle θ toward the ground for more than a predetermined amount of time. The control code may also include fourth instruction means for activating a vibratory indicator if the level sensor 116 indicates that the lens of the video input 126 has been pointing away from a horizontal line parallel to the ground more than a predetermined angle θ toward the ground for more than a predetermined amount of time. The control code may also include fifth instruction means for deactivating the camcorder 100 if the level sensor 116 indicates that the lens of the video input 126 has been pointing away from a horizontal line parallel to the ground more than a predetermined angle θ toward the ground for more than a predetermined amount of time. The control code may also include sixth instruction means for accepting user input to adjust the predetermined angle. The control code may also include seventh instruction means for accepting user input to adjust the predetermined amount of time.

A method for controlling a device equipped with a level sensor determines whether the level sensor indicates that a predetermined position on the device, such as the lens, has been pointing away from a horizontal line parallel to the ground more than a predetermined angle θ toward the ground for more than a predetermined amount of time. The method may also activate an audible indicator if the level sensor indicates that a predetermined position on the device has been pointing away from a horizontal line parallel to the ground more than a predetermined angle θ toward the ground for more than a predetermined amount of time. The method may also activate a visual indicator 122 if the level sensor 116 indicates that a predetermined position on the device has been pointing away from a horizontal line parallel to the ground more than a predetermined angle θ toward the ground for more than a predetermined amount of time. The method may also activate a vibratory indicator if the level sensor 116 indicates that a predetermined position on the device has been pointing away from a horizontal line parallel to the ground more than a predetermined angle θ toward the ground for more than a predetermined amount of time. The method may also deactivate the device if the level sensor 116 indicates that a predetermined position on the device has been pointing away from a horizontal line parallel to the ground more than a predetermined angle θ toward the ground for more than a predetermined amount of time. The method may also accept user input to adjust the predetermined angle. The method may also accept user input to adjust the predetermined amount of time.

While the invention has been described with references to its preferred embodiment, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

I claim:

1. A device comprising:
a power source;
a level sensor interconnected with said power source;
wherein the level sensor detects whether a predetermined position on the device has been pointing from a horizontal line parallel to ground more than a predetermined angle θ toward the ground for more than a predetermined amount of time.

2. The device according to claim 1, further comprising:
a controller;
a memory;
function keys;
an audible indicator;
a visual indicator;
an audio input;
a video input;
at least one input/output connector; and
a communication bus,
wherein the communication bus communicatively interconnects the controller, memory, function keys, audible indicator, visual indicator, audio input, video input, and the at least one input/output connector.

3. The device according to claim 2, wherein said memory includes stored therein control code comprising:
first instruction means for determining whether the level sensor indicates that a predetermined position on the device has been pointing away from a horizontal line parallel to the ground more than a predetermined angle θ toward the ground for more than a predetermined amount of time.

4. The device according to claim 3, wherein said control code further comprises:
second instruction means for activating an audible indicator if the level sensor indicates that a predetermined position on the device has been pointing away from a horizontal line parallel to the ground more than a predetermined angle θ toward the ground for more than a predetermined amount of time.

5. The device according to claim 3, wherein said control code further comprises:
third instruction means for activating a visual indicator if the level sensor indicates that a predetermined position on the device has been pointing away from a horizontal line parallel to the ground more than a predetermined angle θ toward the ground for more than a predetermined amount of time.

6. The device according to claim 3, wherein said control code further comprises:
fourth instruction means for activating a vibratory indicator if the level sensor indicates that a predetermined position on the device has been pointing away from a horizontal line parallel to, the ground more than a predetermined angle θ toward the ground for more than a predetermined amount of time.

7. The device according to claim 3, wherein said control code further comprises:
fifth instruction means for deactivating the device if the level sensor indicates that a predetermined position on the device has been pointing away from a horizontal line parallel to the ground more than a predetermined angle θ toward the ground for more than a predetermined amount of time.

8. The device according to claim 3, wherein said control code further comprises:
sixth instruction means for accepting user input to adjust the predetermined angle.

9. The device according to claim 3, wherein said control code further comprises:
seventh instruction means for accepting user input to adjust the predetermined amount of time.

10. The device according to claim 1, wherein said device is a camcorder.

11. A method for controlling a device equipped with a level sensor, said method comprising:
determining whether the level sensor indicates that a predetermined position on the device has been pointing away from a horizontal line parallel to the ground more than a predetermined angle θ toward the ground for more than a predetermined amount of time.

12. The method according to claim 11, further comprising:
activating an audible indicator if the level sensor indicates that a predetermined position on the device has been pointing away from a horizontal line parallel to the ground more than a predetermined angle θ toward the ground for more than a predetermined amount of time.

13. The method according to claim 11, further comprising:
activating a visual indicator if the level sensor indicates that a predetermined position on the device has been pointing away from a horizontal line parallel to the ground more than a predetermined angle θ toward the ground for more than a predetermined amount of time.

14. The method according to claim 11, further comprising:
activating a vibratory indicator if the level sensor indicates that a predetermined position on the device has been pointing away from a horizontal line parallel to the ground more than a predetermined angle θ toward the ground for more than a predetermined amount of time.

15. The method according to claim 11, further comprising:
deactivating the device if the level sensor indicates that a predetermined position on the device has been pointing away from a horizontal line parallel to the ground more than a predetermined angle θ toward the ground for more than a predetermined amount of time.

16. The method according to claim 11, further comprising:
accepting user input to adjust the predetermined angle.

17. The method according to claim 11, further comprising:
accepting user input to adjust the predetermined amount of time.
